(19) United States
(12) Patent Application Publication
(10) Pub. No.: US 2026/0124968 A1
(43) Pub. Date: May 7, 2026

(54) SEAT CONTROLLING APPARATUS AND METHOD

(71) Applicants: Hyundai Motor Company, Seoul (KR); Kia Corporation, Seoul (KR)

(72) Inventors: Dong Hoon Lee, Hwaseong-Si (KR); Seong Min Kim, Hwaseong-Si (KR); Yo Han Kim, Hwaseong-Si (KR); Mun Seung Kang, Hwaseong-Si (KR)

(21) Appl. No.: 19/227,912

(22) Filed: Jun. 4, 2025

(30) Foreign Application Priority Data
Nov. 5, 2024 (KR) 10-2024-0155656

(51) Int. Cl. B60N 2/14; B60N 2/02; B60R 21/015

(52) U.S. Cl. CPC B60N 2/14; B60N 2/02246; B60R 21/01554

(57) ABSTRACT

An apparatus may comprise a seat rotating circuit comprising a motor configured to swivel a seat, a sensor configured to detect a pulse generated based on driving of the motor, a switch configured to be turned on or off based on a swiveled position of the seat, and a controller circuit configured to determine the swiveled position of the seat based on a number of pulses detected via the sensor, and determine whether to activate a vehicle function based on at least one of the swiveled position of the seat, the number of the detected pulses being within a preset effective range, or the switch being turned on.

### CROSS-REFERENCE TO RELATED APPLICATION

This application claims the benefit of priority to Korean Patent Application No. 10-2024-0155656, filed in the Korean Intellectual Property Office on Nov. 5, 2024, the entire contents of which are incorporated herein by reference.

### TECHNICAL FIELD

The present disclosure relates to a seat controlling apparatus and method.

### BACKGROUND

Seats installed inside a vehicle may rotate via a swivel device. Accordingly, passengers in the vehicle may be arranged to face each other depending on the rotation of the seats. The seats may rotate in a monitor direction so that an image is easily viewed via a pop-up display installed inside the vehicle. Thus, convenience inside the vehicle may be improved.

Passenger expectations for in-vehicle comfort and functionality are evolving, leading to increased interest in enhanced space utilization enabled by adjustable seat positions. This is particularly relevant in vehicles such as electric vehicles, autonomous vehicles, and camping vehicles, where flexible interior layouts may support various use cases (e.g., entertainment, relaxation, or collaboration, etc.).

### SUMMARY

The matters described in this Background section are only for enhancement of understanding of the background of the disclosure, and should not be taken as acknowledgment that they correspond to prior art already known to those skilled in the art.

According to the present disclosure, an apparatus may comprise a seat rotating circuit may comprise a motor configured to swivel a seat, a sensor configured to detect a pulse generated based on driving of the motor, a switch configured to be turned on or off based on a swiveled position of the seat, and a controller circuit configured to, determine the swiveled position of the seat based on a number of pulses detected via the sensor, and determine whether to activate a vehicle function, based on at least one of, the swiveled position of the seat, the number of the detected pulses being within a preset effective range, or the switch being turned on,

The apparatus, wherein the controller circuit is configured to, based on at least one of the swiveled position of the seat being an initial position, the number of the detected pulses being within the preset effective range, or the switch being turned on, activate the vehicle function, and, wherein the vehicle function may comprise gear shifting and driving,

The apparatus may further comprise a command input interface configured to receive a swivel mode switching command for controlling a position of the seat, wherein the controller circuit is configured to, determine, based on the swivel mode switching command, whether to switch a swivel mode, output, based on the determination of whether to switch the swivel mode, a control signal for controlling the driving of the motor, and identify, based on the number of the detected pulses, the swiveled position of the seat,

The apparatus, wherein the controller circuit is configured to, determine the swiveled position of the seat based on a corresponding swivel mode selected from a plurality of swivel modes, wherein each of the plurality of swivel modes is associated with a respective range of a number of pulses detected via the sensor, and wherein each range of a number of pulses detected via the sensor is preset from an operation start time point of the motor to an operation completion time point of the motor for swiveling of the seat,

The apparatus, wherein the plurality of swivel modes comprise a partial swivel mode in which the seat is rotated from a return position corresponding to 0° to a first angle about a reference axis of the seat, a full swivel mode in which the seat is rotated from the return position to a second angle about the reference axis of the seat, and a return swivel mode in which the seat is rotated back to the return position,

The apparatus, wherein the switch is configured to be turned on by physical contact with the seat based on the seat being swiveled to the return position,

The apparatus may further comprise a camera positioned to face the seat and configured to obtain a seat image by photographing at least a portion of the seat,

The apparatus, wherein the controller circuit is configured to determine the swiveled position of the seat based on, a rotation line of an upper plate of the seat rotating circuit and a fixing line of a lower plate of the seat rotating circuit being aligned in a straight vertical line in the seat image, and a position of the seat corresponding to the return swivel mode,

The apparatus, wherein the controller circuit is configured to determine whether to switch the swivel mode based on at least one of, whether power of a vehicle provided with the seat is in a utility mode, a stopped state of the vehicle, a Park-stage state of a transmission provided in the vehicle, a seat seating state of a passenger for the seat, a fastening state of a safety buckle provided in the seat, a manual operation state of the seat, a state in which the return swivel mode of the seat is completed, a swivel operation state of another seat positioned next to the seat, or whether to inflate an airbag of the vehicle provided with the seat,

The apparatus, wherein the controller circuit is configured to, determine whether to inflate the airbag, output, based on the determination of whether to inflate the airbag, information indicating whether inflation of the airbag is unavailable, identify, based on the output information, whether a user agrees to proceed with seat swiveling, and determine whether to swivel the seat based on, the identification of whether the user agrees to proceed with seat swiveling, and a swivel mode switching command received from the user,

According to the present disclosure, a method performed by an apparatus, the method may comprise driving a motor configured to swivel a seat, detecting, via a sensor of the apparatus, a pulse generated based on the driving of the motor, detecting a state of a switch switched based on a swiveled position of the seat, determining the swiveled position of the seat based on a number of pulses detected via the sensor, and determining whether to activate a vehicle function, based on at least one of, the swiveled position of the seat, the number of the detected pulses being within a preset effective range, or the state of the switch,

The method, wherein the determining of whether to activate the vehicle function may comprise activating the vehicle function based on, the swiveled position of the seat being an initial position, the number of the detected pulses being within the preset effective range, or the state of the switch being turned on, and, wherein the vehicle function may comprise a gear shifting and a driving,

The method, further may comprise receiving a swivel mode switching command from a command input interface, determining, based on the swivel mode switching command, whether to switch a swivel mode, and outputting, based on a determination to switch the swivel mode, a control signal for controlling the driving of the motor,

The method, wherein the determining of the swiveled position of the seat may comprise based on a corresponding swivel mode selected from a plurality of swivel modes, determining the swiveled position of the seat, wherein each of the plurality of swivel modes is associated with a respective range of a number of pulses detected via the sensor, and wherein each range of a number of pulses detected via the sensor is preset from an operation start time point of the motor to an operation completion time point of the motor for swiveling of the seat,

The method, wherein the plurality of swivel modes may comprise a partial swivel mode in which the seat is rotated from a return position corresponding to 0° to a first angle about a reference axis of the seat, a full swivel mode in which the seat is rotated from the return position to a second angle about the reference axis of the seat, and a return swivel mode in which the seat is rotated back to the return position,

The method, wherein a seat rotating circuit of the apparatus is configured to swivel the seat via the driving of the motor, and wherein the determining of the swiveled position of the seat is based on, a rotation line of an upper plate of the seat rotating circuit and a fixing line of a lower plate of the seat rotating circuit being aligned in a straight vertical line in a seat image captured by a camera of the apparatus, and a position of the seat corresponding to the return swivel mode,

The method, further may comprise determining whether to switch a swivel mode based on at least one of, whether power of a vehicle provided with the seat is in a utility mode, a stopped state of the vehicle, a Park-stage state of a transmission provided in the vehicle, a seat seating state of a passenger for the seat, a fastening state of a safety buckle provided in the seat, a manual operation state of the seat, a state in which the return swivel mode of the seat is completed, a swivel operation state of another seat positioned next to the seat, or whether to inflate an airbag of the vehicle provided with the seat,

According to the present disclosure, an apparatus of a vehicle, the apparatus may comprise a seat, a motor configured to rotate the seat, and a controller circuit configured to, cause the seat to move into a clearance position before rotating the seat, rotate the seat based on a received mode command, obtain data, via a sensor, indicative of a position of the seat, verify, based on the data, the position of the seat after the rotation, classify the verified position of the seat as one of a plurality of zones, and control, based on the classified one of the plurality of zones, a function of the vehicle,

The apparatus, wherein the function of the vehicle may comprise at least one of, enabling or disabling gear shifting, allowing or preventing vehicle driving, or transitioning a power condition of the vehicle between a utility mode and a driving mode,

The apparatus, wherein the plurality of zones comprise a first zone corresponding to a partial swivel range from a return position to a first angle about a reference axis of the seat, and a second zone corresponding to a full swivel range from the return position to a second angle greater than the first angle,

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a configuration of a seat controlling apparatus according to an example of the present disclosure;

FIG. 2 shows an example of a vehicle to which the seat controlling apparatus is applied and a seat inside the vehicle according to the example of the present disclosure;

FIG. 3 shows an example of a seat and a seat rotating part according to the example of the present disclosure;

FIG. 4 shows an example of a screen for providing a seat position and an airbag operation notification guide according to the example of the present disclosure;

FIG. 5 shows an example of a screen for providing an airbag operation notification guide that is operated as default if seat position identification fails according to the example of the present disclosure;

FIG. 6 shows an example of a seat controlling method for the seat controlling apparatus according to the example of the present disclosure; and

FIG. 7 shows an example of the seat controlling method for the seat controlling apparatus according to the example of the present disclosure.

### DETAILED DESCRIPTION

Hereinafter, some examples of the present disclosure will be described in detail with reference to the exemplary drawings. In adding reference numerals to components of each drawing, it should be noted that identical or equivalent components are designated by an identical numeral even if they are displayed on other drawings. Further, in describing the example of the present disclosure, a detailed description of the related known configuration or function will be omitted if it is determined that the detailed description interferes with the understanding of the example of the present disclosure.

Further, in describing the components of the examples of the present disclosure, terms, such as first, second, “A”, “B”, (a), and (b) may be used. These terms are merely intended to distinguish one component from other components, and the terms do not limit the nature, order, or sequence of the components. Unless otherwise defined, all terms including technical and scientific terms used herein include the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present disclosure, a “controller” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

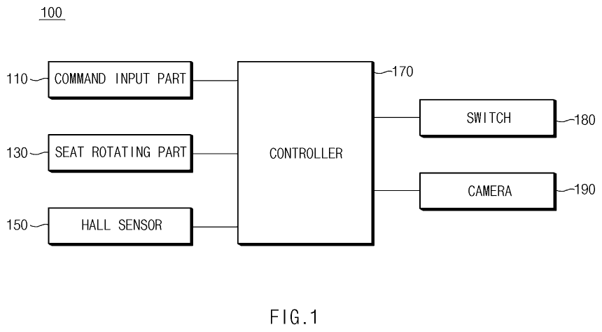

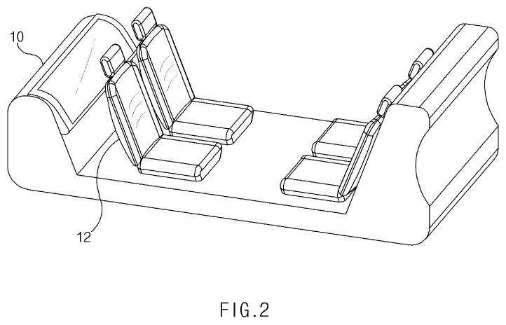

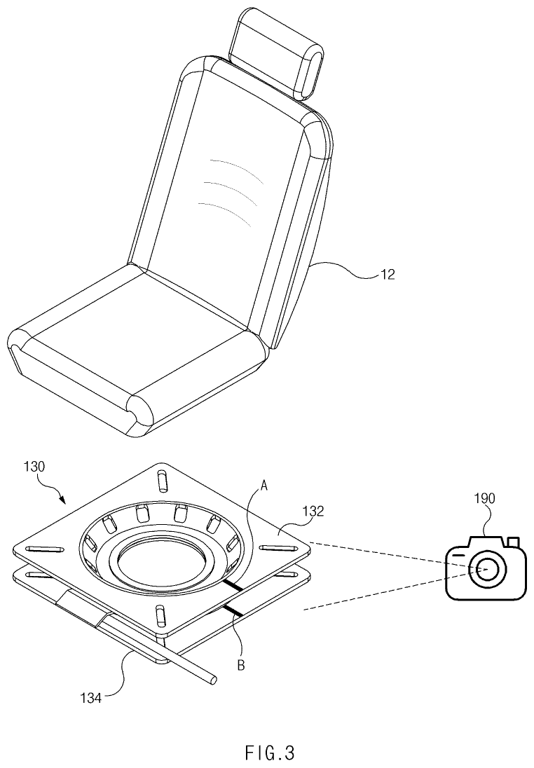

FIG. 1 shows an example of a configuration of a seat controlling apparatus according to an example of the present disclosure, FIG. 2 shows an example of a vehicle to which the seat controlling apparatus is applied and a seat inside the vehicle according to the example of the present disclosure, and FIG. 3 shows an example of a seat and a seat rotating part according to the example of the present disclosure.

A seat controlling apparatus 100 according to an example of the present disclosure may include a command input part 110, a seat rotating part 130, a Hall sensor 150, and a controller 170.

At least one seat 12 installed inside a vehicle 10 may rotate via the seat controlling apparatus 100. Accordingly, passengers in the vehicle 10 are arranged to face each other depending on the rotation of the seat 12 or the seat 12 may be disposed in a monitor direction so that an image is easily viewed via a pop-up display installed inside the vehicle 10 (e.g., for watching videos, participating in conference calls, or viewing navigation content, etc.). Thus, convenience inside the vehicle 10 may be achieved.

The command input part 110 may include a swivel selection mode button provided on one side surface of the seat 12, and the swivel selection mode button may be divided and provided into a plurality of parts according to a swivel mode (e.g., partial swivel, full swivel, or return swivel, etc.).

A plurality of swivel modes may include a partial swivel mode in which the seat 12 is rotated from a return position corresponding to 0° to a first angle about a reference axis of the seat 12, a full swivel mode in which the seat 12 is rotated from the return position to a second angle about the reference axis of the seat 12, and a return swivel mode in which the seat 12 returns to the return position. Here, the term return position may be replaced with an “initial position”.

The first angle may be 0° to 10° about the reference axis of the seat 12, the second angle may be 180° about the reference axis of the seat 12, and these angles are merely an example and may be changed according to an initial setting or a user setting (e.g., based on seat design, display alignment, or user preference, etc.).

The partial swivel mode, which is a mode in which the seat 12 is rotated by a predetermined angle toward an inside of the vehicle 10, may be, for example, a mode which may be performed from the return position and in which the seat 12 is rotated in the monitor direction so that the image is easily viewed via the pop-up display installed inside the vehicle 10 (e.g., for rear passengers to view entertainment content or for front-seat occupants to view center-mounted displays, etc.).

The full swivel mode may be a mode which may be performed from the return position and is configured to support a conversation mode by rotating in a direction facing a front row seat or a rear row seat (e.g., enabling face-to-face interactions, conference-style discussions, or collaborative in-vehicle activities, etc.).

The return swivel mode may be a mode in which a position of the seat 12 corresponds to the initial position at which a vehicle function may be activated (e.g., enabling engine start, allowing drive mode engagement, or initiating power transitions, etc.).

The return swivel mode may be a mode corresponding to a position in which a position of a seat of a driver may allow activation of the vehicle function, including gear shifting, driving, and power condition transition (e.g., switching from a utility mode to a driving mode, enabling autonomous driving handoff, or resuming navigation-based driving control, etc.).

The utility mode may include, for example, an image viewing mode via the pop-up display provided in the vehicle 10, a conversation mode in which the seat 12 is swiveled to enable conversation between passengers in a first row seat and a second row seat, a relaxation mode for resting or reclining, or a conference mode for collaborative discussions, etc.

The return swivel mode may be a mode in which the seat 12 mechanically reaches the return position, an error occurs in the Hall sensor 150, and the seat 12 is swiveled to a position in which a switch 180 turned on by physical contact with the seat 12 is turned on. The return swivel mode operation may be performed from any rotated position of the seat and throughout the entire swivel range.

The above-described swivel modes are examples of classifying the plurality of swivel modes, and a swivel mode classified based on a rotation angle of the seat 12 and rotation directions corresponding to an outward vehicle direction CW or an inward vehicle direction CCW may be further added (e.g., a 90° half swivel for partial conversations, a 45° offset for angled viewing, or reverse CW/CCW directionality for passenger-side or driver-side configurations, etc.).

In addition to defining swivel modes, the seat controlling apparatus 100 may execute a Pre-Swivel operation prior to executing a swivel mode to avoid mechanical interference between seat components. The Pre-Swivel operation may involve adjusting other seat motors—such as reclining, tilting, longitudinal translation, or height motors—to positions that provide sufficient clearance for safe swiveling. After completion of the swivel operation, an After-Swivel operation may be performed to reposition the seat into a target configuration prepared or optimized for the selected swivel mode. For example, in the full swivel mode, the After-Swivel operation may adjust the seat to a conversation-friendly posture, whereas for partial swivel, the After-Swivel operation may position the seat toward a display viewing angle. The overall control sequence may proceed as: Pre-Swivel→Swivel→After-Swivel.

The command input part 110 may receive a swivel mode switching command for controlling the position of the seat 12. For example, the command input part 110 may receive the swivel mode switching command via an input of a swivel selection mode button from a user. Alternatively, the command input part 110 may receive the swivel mode switching command from the user via a terminal connected to the seat controlling apparatus 100 via wired or wireless communication (e.g., via a touchscreen interface, a smartphone app, a central console UI, or a voice recognition system, etc.).

The seat rotating part 130 may swivel the seat 12 via driving of a motor (not illustrated). A driving of the motor may be controlled by a control signal transmitted from the controller 170. A driving shaft of the motor may rotate, and a rotation direction of the seat 12 may be changed according to a rotation direction of the driving shaft (e.g., clockwise or counterclockwise to accommodate different cabin layouts or seat orientations, etc.).

The Hall sensor 150 may detect a pulse caused by a change in a magnetic field generated according to the driving of the motor (e.g., during initial acceleration, deceleration, or direction reversal, etc.).

In detail, rotation according to the swiveling may occur between an upper plate 132 and a lower plate 134 of the seat rotating part 130. A magnet and the Hall sensor 150 for measuring the amount of rotation according to the swiveling may be coupled to each other, the magnet may be coupled to a surface of the upper plate 132 facing the lower plate 134, and the Hall sensor 150 configured to detect a change in a magnetic field of this magnet may be coupled to the lower plate 134.

The Hall sensor 150 is a sensor that detects the change in the magnetic field of the magnet, and the Hall sensor 150 detects the change in the magnetic field of the magnet as the upper plate 132 swivels and rotates (e.g., in response to user-initiated swivel commands or automated return-to-home operations, etc.).

For example, if the magnet is coupled to the upper plate 132 while divided into an N pole and an S pole, as the upper plate 132 swivels and rotates, the magnetism of the magnet corresponding to the Hall sensor 150 relatively changes from the N pole to the S pole or from the S pole to the N pole. Moreover, even if the magnet is present in the same area of the N pole, a strength of the magnetic field changes according to the amount of rotation. The Hall sensor 150 may detect a pulse representing the change in the magnetism or the magnetic field to measure the amount of rotation of the upper plate 132 (e.g., to determine the angle of rotation corresponding to partial, full, or return swivel modes, etc.).

In this way, the controller 170 may identify the position of the seat 12 based on the number of pulses generated by the magnetic field detected via the Hall sensor 150 (e.g., to determine whether the seat is in a return, partial, or full swivel position, etc.).

The controller 170 may determine the position of the seat 12 based on a swivel mode, corresponding to the number of counted pulses, among the plurality of swivel modes (e.g., using pulse thresholds predefined for return swivel, partial swivel, or full swivel operations, etc.).

Here, each of the plurality of swivel modes may be mapped by presetting a range of the number of pulses due to the change in the magnetic field detected via the Hall sensor 150 from an operation start time point to an operation completion time point of the motor (e.g., mapping 0-X pulses to partial swivel, X-Y pulses to full swivel, or Y+ pulses to out-of-range or fault states, etc.).

The controller 170 may classify the position of the seat during swivel operation into distinct ranges referred to as Zone1 and Zone2 based on the total number of detected Hall sensor pulses. For example, Zone1 may refer to the range between the return swivel position and the partial swivel position. Zone2 may refer to the range between the partial swivel position and the full swivel position. If the swivel operation stops in a location where the pulse count does not precisely match a known swivel mode threshold (due to motor obstruction or user interruption), the controller 170 may use the pulse range classification to infer an approximate seat region. This zone classification may be used for error handling, airbag logic, or conditional mode switching.

As described above, the plurality of swivel modes may include the partial swivel mode in which the seat 12 is rotated from the return position corresponding to 0° to the first angle about the reference axis of the seat 12, the full swivel mode in which the seat 12 is rotated from the return position to the second angle about the reference axis of the seat 12, and the return swivel mode in which the seat 12 returns to the return position (e.g., 0° for driving posture, 10° for display viewing, or 180° for rear-facing conversation, etc.). This is an example of classifying the plurality of swivel modes, and a swivel mode classified based on the rotation angle and the rotation direction of the seat 12 may be further added (e.g., a 90° intermediate swivel for side-access entry, a 45° diagonal alignment swivel for side-facing displays, or mode variants based on clockwise or counterclockwise rotation, etc.).

The seat controlling apparatus 100 may further include the switch 180 that is turned on by the physical contact with the seat 12 if the seat 12 is swiveled to the return position (e.g., using a mechanical microswitch, proximity-based actuator, or compression-activated trigger, etc.).

The switch 180 may be provided in a peripheral area of the seat 12, may be a switch turned on if the switch is physically in contact with the seat 12 during the swivel operation of the seat 12 and turned off if the switch is not physically in contact with the seat 12, and may be set to be turned on if the seat 12 returns to the initial position i.e., a position at which vehicle functions are permitted to activate.

If it is identified that the position of the seat 12 corresponds to the return swivel mode, the controller 170 may determine the position of the seat 12 further in consideration of whether the switch 180 is turned on to confirm physical positioning.

For example, as a result of counting the number of the pulses due to the change in the magnetic field detected via the Hall sensor 150, if it is identified that the counted number of the pulses corresponds to the return swivel mode, the controller 170 may determine that the position of the seat 12 corresponds to the return swivel mode only if the switch 180 is turned on (e.g., as an additional safety confirmation of physical seat alignment, etc.).

On the other hand, as a result of counting the number of the pulses due to the change in the magnetic field detected via the Hall sensor 150, even if it is identified that the counted number of the pulses corresponds to the return swivel mode, if the switch 180 is turned off, the controller 170 may not determine that the position of the seat 12 corresponds to the return swivel mode (e.g., due to mechanical misalignment, foreign object obstruction, or seat bounce-back preventing full engagement with the switch, etc.). In this case, the operation for identifying the position of the seat may be performed again, a seat position determination failure notification may be output to the user, or the user may be guided to re-input the swivel mode switching command (e.g., by alerting the user via dashboard UI, audio prompts, or in-app notifications, etc.).

Meanwhile, the controller 170 may determine activation of the vehicle function based on at least one of the position of the seat, whether the number of the detected pulses is within a preset effective range, and whether the switch 180 is turned on (e.g., to verify that driving-related operations are safe to proceed, etc.).

Here, the vehicle functions may include gear shifting, vehicle driving, and power condition transition (e.g., switching from the utility mode to the driving mode, enabling autonomous handoff, or permitting battery recharge states, etc.).

In the example, if the position of the seat is the initial position, if the number of the detected pulses is within the preset effective range, or if the switch 180 is turned on, the controller 170 may determine to activate the vehicle function (e.g., enabling gear shift, engaging driving mode, or resuming autonomous driving, etc.).

On the other hand, if the position of the seat is not the initial position, if the number of the detected pulses does not correspond to the preset effective range, and if the switch 180 is not turned on, the controller 170 may prevent the vehicle function from being activated. Accordingly, if the position of the seat is a position or state unsuitable for driving the vehicle, the vehicle function may enter an inactivated state, thereby promoting the safety of the driver and the vehicle (e.g., blocking driving start, disabling acceleration, or restricting transmission operation, etc.).

The seat controlling apparatus 100 may further include a camera 190 that is provided around the seat 12 inside the vehicle 10 and obtains a seat image by photographing at least a portion of the seat 12 (e.g., top-down, side-angle, or alignment-view perspective, etc.).

If it is identified that the position of the seat 12 corresponds to the return swivel mode, the controller 170 may determine the position of the seat 12 further in consideration of whether a rotation line “A” of the upper plate 132 and a fixing line “B” of the lower plate 134 of the seat rotating part 130 are arranged in a straight line on a vertical line in the seat image (e.g., aligned within a predefined pixel threshold, contour match, or edge detection range, etc.).

For example, as a result of counting the number of the pulses due to the change in the magnetic field detected via the Hall sensor 150, if it is identified that the counted number of the pulses corresponds to the return swivel mode, then only if it is determined that the rotation line “A” of the upper plate 132 and the fixing line “B” of the lower plate 134 of the seat rotating part 130 are arranged in a straight line on the vertical line in the seat image obtained via the camera 190, the controller 170 may determine that the position of the seat 12 corresponds to the return swivel mode (e.g., when the lines are visually aligned within a tolerance range using edge detection, optical pattern matching, or pixel alignment algorithms, etc.).

On the other hand, as a result of counting the number of the pulses due to the change in the magnetic field detected via the Hall sensor 150, even if it is identified that the counted number of the pulses corresponds to the return swivel mode, if it is determined that the rotation line “A” of the upper plate 132 and the fixing line “B” of the lower plate 134 of the seat rotating part 130 are not arranged in a straight line on the vertical line in the seat image obtained via the camera 190, the controller 170 may not determine that the position of the seat 12 corresponds to the return swivel mode (e.g., due to image distortion, obstruction, or misalignment beyond an acceptable threshold, etc.). In this case, the operation for identifying the position of the seat may be performed again, the seat position determination failure notification may be output to the user, or the user may be guided to re-input the swivel mode switching command (e.g., via touchscreen prompt, voice alert, or connected mobile device message, etc.).

If it is identified that the position of the seat 12 corresponds to the full swivel mode, the controller 170 may determine the position of the seat 12 further in consideration of whether an error occurs in the Hall sensor 150. For example, the controller 170 may determine that the position of the seat 12 corresponds to the full swivel mode only if the number of the pulses generated via the Hall sensor 150 corresponds to the full swivel mode and the error occurs in the Hall sensor 150 at a time point when the swivel operation is terminated (e.g., due to mechanical end-stop, sensor overrange, or stall detection at maximum rotation, etc.).

The controller 170 may determine whether to switch the swivel mode in response to an input of the swivel mode switching command and output a control signal for controlling the driving of the motor based on the determination result (e.g., initiate seat rotation, maintain current mode, or reject the command with a user notification, etc.).

To this end, the controller 170 may determine whether the swivel mode may be switched, based on at least one of whether the power of the vehicle 10 provided with the seat 12 is in the utility mode, a stopped state of the vehicle 10, a P-stage state of a transmission provided in the vehicle 10, a seat seating state of the passenger for the seat 12, a fastening state of a safety buckle provided in the seat 12, a manual operation state of the seat 12, a state in which the return swivel mode of the seat 12 is completed, a swivel operation state of another seat positioned next to the seat 12, and whether an airbag of the vehicle provided with the seat 12 may be inflated (e.g., during startup checks, multi-seat synchronization, or occupant presence verification, etc.).

Further, the controller 170 may determine whether the airbag may be inflated according to the position of the seat 12 in response to the input of the swivel mode switching command. Accordingly, the controller 170 may output determined information on whether the airbag may be inflated (e.g., notify the user if deployment is disabled due to seat misalignment or active swivel mode, etc.).

Here, if outputting airbag inflation unavailability information as whether the airbag may be inflated, after identifying whether the user agrees to switch to the swivel mode, the controller 170 may swivel the seat 12 according to the swivel mode switching command input into the command input part 110 if the user agrees (e.g., after pressing a confirmation button, acknowledging a warning message, or confirming via touchscreen UI, etc.).

On the other hand, if outputting the airbag inflation unavailability information as whether the airbag may be inflated, if identifying whether the user agrees to switch to the swivel mode, the controller 170 may determine whether to swivel the seat 12 according to the swivel mode switching command input into the command input part 110 if the user does not agree (e.g., cancel the swivel action, prompt the user again, or maintain the current position for safety, etc.).

For example, even if the swivel mode switching command is input into the command input part 110, if the user selects an option not to switch to the swivel mode with respect to the airbag inflation unavailability information, the switching of the swivel mode may be stopped at a later stage (e.g., during safety verification, confirmation timeout, or system override, etc.).

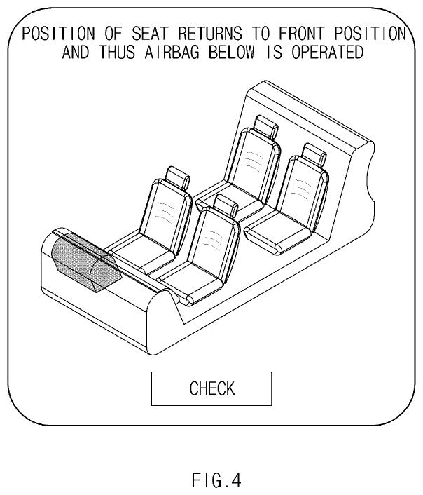

In this case, for example, as illustrated in FIG. 4, the controller 170 may provide, to the user, a notification that the position of the seat 12 returns to a front position, and thus the airbag is operated (e.g., enabling normal airbag deployment based on verified alignment, etc.).

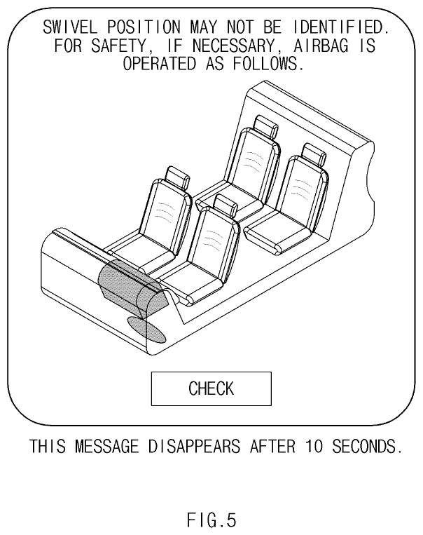

As another example, as illustrated in FIG. 5, if the controller 170 fails to identify the position of the swiveled seat 12, the controller 170 may provide a notification that default airbags are operated such that the airbags are operated to a minimum for safety (e.g., to reduce deployment force, suppress certain zones, or limit to essential frontal bags only, etc.).

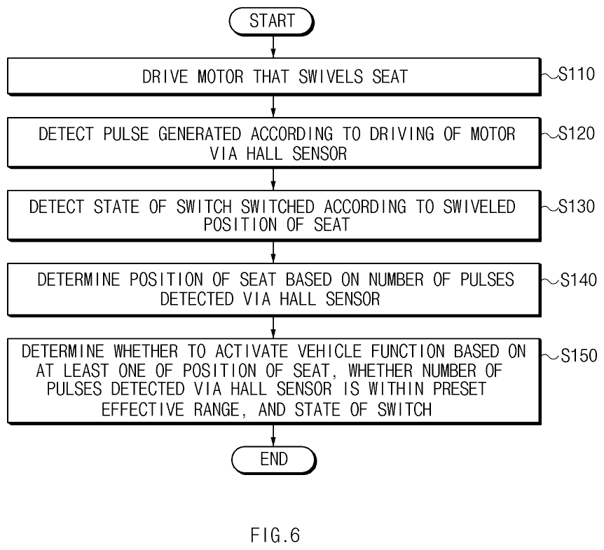

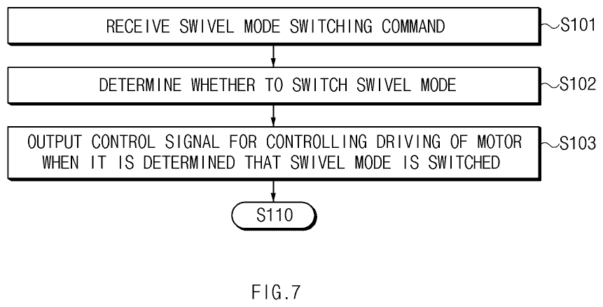

FIG. 6 and FIG. 7 are flowcharts for describing a seat controlling method for the seat controlling apparatus according to the example of the present disclosure. The same description as that related to the seat controlling apparatus described with reference to FIGS. 1 to 5 will be omitted to avoid redundancy.

As illustrated in FIG. 6, a controller constituting the seat controlling apparatus may first drive a motor that swivels a seat (S110) (e.g., by supplying power, releasing a lock, or initializing the swivel control loop, etc.).

Next, the controller may detect a pulse generated according to the driving of the motor via a Hall sensor (S120) (e.g., by counting transitions caused by magnetic field changes as the seat rotates, etc.).

Here, the Hall sensor 150 may detect a pulse caused by a change in a magnetic field generated according to the driving of the motor (e.g., due to rotational displacement of a magnet attached to the seat structure, gear rotation, or incremental angular motion, etc.). In detail, as illustrated in FIG. 3, rotation of the seat according to the swiveling may occur between the upper plate 132 and the lower plate 134 of the seat rotating part 130 (e.g., via a rotating bearing, pivot mechanism, or motor-driven interface, etc.). The magnet and the Hall sensor 150 for measuring the amount of rotation according to the swiveling may be coupled to each other, the magnet may be coupled to the surface of the upper plate 132 facing the lower plate 134, and the Hall sensor 150 that detects the change in the magnetic field of this magnet may be coupled to the lower plate 134 (e.g., mounted at an offset or aligned concentrically to ensure continuous signal detection, etc.).

The Hall sensor 150 is a sensor that detects the change in the magnetic field of the magnet, and the Hall sensor 150 detects the change in the magnetic field of the magnet as the upper plate 132 swivels and rotates (e.g., producing a digital pulse output or analog voltage waveform correlated to angular movement, etc.).

For example, if the magnet is coupled to the upper plate 132 and divided into an N pole and an S pole, as the upper plate 132 swivels and rotates, the magnetism of the magnet corresponding to the Hall sensor 150 may relatively change from the N pole to the S pole or from the S pole to the N pole (e.g., due to rotational displacement causing polarity reversal at the sensor's detection axis, etc.). Further, even if the magnet remains within the same area of the N pole, the strength of the magnetic field may change according to the amount of rotation (e.g., due to angular variation in field intensity, sensor orientation, or magnetic gradient effects, etc.). The Hall sensor 150 may detect a pulse representing the change in the magnetism or the magnetic field to measure the amount of rotation of the upper plate 132 (e.g., detecting incremental changes in magnetic flux to estimate angular displacement, seat alignment, or rotation direction, etc.).

Next, the controller may detect a state of the switch that is switched according to the swiveled position of the seat (S130) (e.g., using a mechanical limit switch, contact sensor, or magnetic reed switch, etc.).

Here, the switch may be provided in a peripheral area of the seat, may be a switch turned on if the switch is physically in contact with the seat during the swivel operation of the seat (e.g., when the seat reaches a predefined rotational endpoint or engages a mechanical stop, etc.) and may be set to be turned off if the switch is not physically in contact with the seat (e.g., when the seat is rotated away from the return position or disengages the switch surface, etc.), and may be set to be turned on if the seat returns to the initial position thereof, i.e., at a position of the seat at which the vehicle function may be activated (e.g., enabling gear shift, propulsion, or regenerative braking, etc.).

Next, the controller may determine the position of the seat based on the number of the pulses detected via the Hall sensor (S140) (e.g., comparing pulse count to preset thresholds for return, partial, or full swivel states, etc.). For example, the position of the seat may be determined based on the number of the pulses detected via the Hall sensor that detects the pulse due to the change in the magnetic field generated according to the driving of the motor (e.g., to identify specific angular positions for swivel mode classification, seat alignment, or safety validation, etc.).

To this end, the controller may determine the position of the seat 12 based on a swivel mode that corresponds to the number of the counted pulses, among the plurality of swivel modes.

Here, each of the plurality of swivel modes may be mapped by presetting a range of the number of the pulses due to the change in the magnetic field detected via the Hall sensor 150 from the operation start time point to the operation completion time point of the motor (e.g., defining a specific pulse range for partial swivel, full swivel, or return swivel, etc.).

As described above, the plurality of swivel modes may include the partial swivel mode in which the seat 12 is rotated from the return position corresponding to 0° to the first angle about the reference axis of the seat 12, the full swivel mode in which the seat 12 is rotated from the return position to the second angle about the reference axis of the seat 12, and the return swivel mode in which the seat 12 returns to the initial position (e.g., 0° for front-facing driving, 10° for display alignment, or 180° for full rear-facing orientation, etc.). This is an example of classifying the plurality of swivel modes, and additional swivel mode types classified based on the rotation angle and the rotation direction of the seat 12 may be further added (e.g., a 90°side-facing mode, a 135° diagonal mode, or direction-specific variants such as clockwise or counterclockwise full swivel, etc.).

Among them, the return swivel mode may be a mode in which the position of the seat corresponds to the initial position at which the vehicle function may be activated (e.g., enabling drive mode, unlocking the transmission, or starting engine operation, etc.).

The return swivel mode may be a mode corresponding to a position in which the position of the seat of the driver may allow activation of the vehicle function, including gear shifting, driving, and power condition transition (e.g., switching from a utility mode to a driving mode, re-engaging propulsion systems, or allowing manual override, etc.).

The utility mode may include, for example, an image viewing mode via the pop-up display provided in the vehicle, a conversation mode in which the seat is swiveled to enable the conversation between the passengers in the first row seat and the second row seat, a relaxation mode for resting configurations, or a work mode for screen-based tasks, etc.

The return swivel mode may be a mode in which the seat mechanically reaches the initial position, an error occurs in the Hall sensor 150, and the seat is swiveled to a position in which the switch is turned on due to the physical contact with the seat. The operation of the return swivel mode may be performed from any previous swivel mode or position and may span the entire section (e.g., the entire rotational range, enabling safe transition from full swivel back to driving position, regardless of swivel direction or stopping point, etc.).

Next, the controller may determine the activation of the vehicle function based on at least one of the position of the seat, whether the number of the pulses detected via the Hall sensor is within the preset effective range, and the state of the switch (S150) (e.g., by cross-verifying position data, seat alignment, or return confirmation, etc.).

In the example, if the position of the seat is the initial position, if the number of the detected pulses is within the preset effective range, or if the switch is turned on, the controller may determine to activate the vehicle function (e.g., enabling engine start, unlocking gear shift, or resuming cruise control, etc.).

On the other hand, if the position of the seat is not the initial position, if the number of the detected pulses does not correspond to the preset effective range, and if the switch is not turned on, the controller may enter a state in which the vehicle function is inhibited from being activated (e.g., disabling driving mode, preventing powertrain engagement, or restricting gear shift operations, etc.). Accordingly, if the position of the seat is a position or state unsuitable for driving the vehicle, the vehicle function may be prevented from being activated, thereby promoting the safety of the driver and the vehicle (e.g., preventing accidental gear engagement, propulsion, or battery handover in non-driving configurations, etc.).

Here, the controller may receive a swivel mode switching command from a command input part before the operation S110 of driving the motor (e.g., at the request of the user or triggered by a system routine such as entry, exit, or infotainment transition, etc.).

To this end, the command input part may receive the swivel mode switching command for controlling the position of the seat (e.g., initiating partial swivel, full swivel, or return to driving position, etc.). For example, the command input part may receive the swivel mode switching command via a user's input of the swivel selection mode button, for example, located on the seat or nearby control panel. Alternatively, the command input part may receive the swivel mode switching command from the user via the terminal connected to the seat controlling apparatus via wired or wireless communication (e.g., through a touchscreen panel, smartphone app, key fob, or voice assistant interface, etc.).

The command input part 110 may include a swivel selection mode button provided on one side surface of the seat, and the swivel selection mode button may be divided and provided into a plurality of parts according to the swivel mode (e.g., partial, full, or return swivel mode, or customized memory modes, etc.).

Next, the controller may determine whether the swivel mode may be switched (S102) (e.g., based on current seat state, vehicle condition, or driver/passenger safety context, etc.).

To this end, the controller may determine whether the swivel mode may be switched, based on at least one of whether the power of the vehicle provided with the seat is in the utility mode, the stopped state of the vehicle, the P-stage state of the transmission provided in the vehicle, the seat seating state of the passenger for the seat, the fastening state of the safety buckle provided in the seat, the manual operation state of the seat, the state in which the return swivel mode of the seat is completed, the swivel operation state of another seat positioned next to the seat, and whether the airbag of the vehicle provided with the seat may be inflated (e.g., checking if the vehicle is parked, the seat is unoccupied, or the adjacent seat is locked in place, etc.).

Next, if it is determined that the swivel mode may be switched, the controller may output the control signal for controlling the driving of the motor that swivels the seat based on the determination result (S103) (e.g., to initiate partial, full, or return swivel rotation, etc.).

The driving of the motor may be controlled by the control signal transmitted from the controller, the driving shaft may be rotated by the controlled motor, and the rotation direction of the seat may be changed according to the rotation direction of the driving shaft (e.g., clockwise for rightward swivel or counterclockwise for leftward swivel, depending on the selected mode, etc.). Accordingly, the seat may be swiveled by an angle corresponding to the swivel mode input as the swivel mode switching command (e.g., 10°, 90°, or 180° depending on user selection or preset configuration, etc.).

On the other hand, if it is determined that the switching mode may not be switched, the user may be notified of the fact that the swivel mode may not be switched or may be guided to re-input the swivel mode switching command (e.g., via an in-vehicle display, audio alert, or connected mobile app, etc.).

An example of the present disclosure provides a seat controlling apparatus and method capable of allowing a user to safely use a swivel function by identifying a swiveled position of a seat, determining whether to inflate an airbag based on the position of the seat, and notifying the user of the determination result.

Another example of the present disclosure provides a seat controlling apparatus and method capable of promoting safety of a vehicle and a driver by allowing vehicle functions including gear shifting or driving to enter a non-activatable state if a swivel seat of the driver does not return to an initial position thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a seat controlling apparatus includes a seat rotating part including a motor that swivels a seat, a Hall sensor that detects a pulse generated according to driving of the motor, a switch turned on/off according to a swiveled position of the seat, and a controller that determines the position of the seat based on the number of the pulses detected via the Hall sensor, wherein the controller determines whether to activate a vehicle function, based on at least one of the position of the seat, whether the number of the detected pulses is within a preset effective range, and whether the switch is turned on.

According to an example, the controller may activate the vehicle functions if the position of the seat is an initial position, if a value of the Hall sensor is within the preset effective range, or if the switch is turned on, and the vehicle functions may include gear shifting and driving.

According to an example, the seat controlling apparatus may further include a command input part that receives a swivel mode switching command for controlling the position of the seat, wherein the controller may determine whether to switch a swivel mode in response to an input of the swivel mode switching command, output a control signal for controlling the driving of the motor based on the determination result, and identify the position of the seat based on the number of the pulses detected via the Hall sensor.

According to an example, the controller may determine the position of the seat based on a corresponding swivel mode among a plurality of swivel modes based on the number of the detected pulses, and each of the plurality of swivel modes may be mapped by presetting a range of the number of pulses detected via the Hall sensor from an operation start time point to an operation completion time point of the motor.

According to an example, the plurality of swivel modes may include a partial swivel mode in which the seat is rotated from a return position corresponding to 0° to a first angle about a reference axis of the seat, a full swivel mode in which the seat is rotated from the return position to a second angle about the reference axis of the seat, and a return swivel mode in which the seat returns to the return position.

According to an example, the switch may be turned on by physical contact with the seat if the seat is swiveled to the return position.

According to an example, the seat controlling apparatus may further include a camera that is provided around the seat and obtains a seat image by photographing the seat.

According to an example, the controller may determine the position of the seat further in consideration of whether a rotation line of an upper plate and a fixing line of a lower plate of the seat rotating part are arranged in a straight line on a vertical line in the seat image if it is identified that the position of the seat corresponds to the return swivel mode.

According to an example, the controller may determine whether to switch the swivel mode, based on at least one of whether power of a vehicle provided with the seat is in a utility mode, a stopped state of the vehicle, a P-stage state of a transmission provided in the vehicle, a seat seating state of a passenger for the seat, a fastening state of a safety buckle provided in the seat, a manual operation state of the seat, a state in which the return swivel mode of the seat is completed, a swivel operation state of another seat positioned next to the seat, and whether to inflate an airbag of the vehicle provided with the seat.

According to an example, the controller may determine whether to inflate the airbag, output whether to inflate the airbag based on the determination result, identify whether a user agrees to airbag inflation unavailability information if the airbag inflation unavailability information is output as whether to inflate the airbag, and determine whether to swivel the seat according to the swivel mode switching command input later based on the user agreement identification result.

According to another example of the present disclosure, a seat controlling method includes driving a motor that swivels a seat, detecting a pulse generated according to the driving of the motor via a Hall sensor, detecting turn-on/turn-off of a switch of which a state is switched according to the swiveled position of the seat, determining the position of the seat based on the number of the pulses detected via the Hall sensor, and determining whether to activate a vehicle function, based on at least one of the position of the seat, whether a value of the Hall sensor detected via the Hall sensor is within a preset effective range, and whether the switch is turned on.

According to an example, in the determining of whether to activate the vehicle function, the vehicle functions may be activated if the position of the seat is an initial position, if a value of the Hall sensor is within a preset effective range, or if the switch is turned on, and the vehicle functions may include gear shifting and driving.

According to an example, the seat controlling method may further include receiving a swivel mode switching command from a command input part, determining whether to switch a swivel mode, and outputting a control signal for controlling the driving of the motor based on a determination result if it is determined that the swivel mode is switched.

According to an example, in the determining of the position of the seat, the position of the seat may be determined based on a corresponding swivel mode among a plurality of swivel modes based on the number of the detected pulses, and each of the plurality of swivel modes may be mapped by presetting a range of the number of pulses detected via the Hall sensor from an operation start time point to an operation completion time point of the motor.

According to an example, the plurality of swivel modes may include a partial swivel mode in which the seat is rotated from a return position corresponding to 0° to a first angle about a reference axis of the seat, a full swivel mode in which the seat is rotated from the return position to a second angle about the reference axis of the seat, and a return swivel mode in which the seat returns to the return position.

According to an example, in the determining of the position of the seat, the position of the seat may be determined further in consideration of whether a rotation line of an upper plate and a fixing line of a lower plate of a seat rotating part that swivels the seat via the driving of the motor are arranged in a straight line on a vertical line in a seat image captured by a camera if it is identified that the position of the seat corresponds to the return swivel mode.

According to an example, the seat controlling method may further include determining whether to switch the swivel mode, based on at least one of whether power of a vehicle provided with the seat is in a utility mode, a stopped state of the vehicle, a P-stage state of a transmission provided in the vehicle, a seat seating state of a passenger for the seat, a fastening state of a safety buckle provided in the seat, a manual operation state of the seat, a state in which the return swivel mode of the seat is completed, a swivel operation state of another seat positioned next to the seat, and whether to inflate an airbag of the vehicle provided with the seat.

According to an example, the seat controlling method may further include, after the determining of the position of the seat, determining whether to inflate the airbag based on the position of the seat and outputting whether to inflate the airbag based on the determination result.

According to an example, the seat controlling method may further include identifying whether a user agrees to airbag inflation unavailability information if the airbag inflation unavailability information is output as whether to inflate the airbag.

According to an example, the seat controlling method may further include determining whether to swivel the seat according to the swivel mode switching command input later based on the user agreement identification result.

According to the present disclosure, the position of the swiveled seat may be quickly identified only by a function of counting the number of the pulses detected via the Hall sensor.

Further, according to the present disclosure, the controller may determine whether the airbag may be inflated based on the identified position of the seat and notify the user of whether the airbag may be inflated, and thus the user may conveniently and safely use the swivel function of the seat

In addition, according to the present disclosure, if the swivel seat of the driver does not return to the initial position thereof, the gear shifting or the driving of the vehicle may enter an impossible state, and thus the vehicle may be safely driven.

The above description is merely illustrative of the technical spirit of the present disclosure, and those skilled in the art to which the present disclosure belongs may make various modifications and changes without departing from the essential features of the present disclosure. Thus, the examples disclosed in the present disclosure are not intended to limit the technology spirit of the present disclosure but are intended to describe the present disclosure, and the scope of the technical spirit of the present disclosure is not limited by these examples. The scope of protection of the present disclosure should be interpreted by the appended claims, and all technical spirits within the scope equivalent thereto should be interpreted as being included in the scope of the present disclosure.

What is claimed:

1. An apparatus comprising:
a seat rotating circuit comprising a motor configured to swivel a seat;
a sensor configured to detect a pulse generated based on driving of the motor;
a switch configured to be turned on or off based on a swiveled position of the seat; and
a controller circuit configured to:
determine the swiveled position of the seat based on a number of pulses detected via the sensor, and
determine whether to activate a vehicle function, based on at least one of:
the swiveled position of the seat,
the number of the detected pulses being within a preset effective range, or
the switch being turned on.

2. The apparatus of claim 1, wherein the controller circuit is configured to:
based on at least one of the swiveled position of the seat being an initial position, the number of the detected pulses being within the preset effective range, or the switch being turned on, activate the vehicle function, and
wherein the vehicle function comprises gear shifting and driving.

3. The apparatus of claim 1, further comprising:
a command input interface configured to receive a swivel mode switching command for controlling a position of the seat,
wherein the controller circuit is configured to:
determine, based on the swivel mode switching command, whether to switch a swivel mode;
output, based on the determination of whether to switch the swivel mode, a control signal for controlling the driving of the motor; and
identify, based on the number of the detected pulses, the swiveled position of the seat.

4. The apparatus of claim 3, wherein the controller circuit is configured to:
determine the swiveled position of the seat based on a corresponding swivel mode selected from a plurality of swivel modes,
wherein each of the plurality of swivel modes is associated with a respective range of a number of pulses detected via the sensor, and
wherein each range of a number of pulses detected via the sensor is preset from an operation start time point of the motor to an operation completion time point of the motor for swiveling of the seat.

5. The apparatus of claim 4, wherein the plurality of swivel modes comprise:
a partial swivel mode in which the seat is rotated from a return position corresponding to 0° to a first angle about a reference axis of the seat;
a full swivel mode in which the seat is rotated from the return position to a second angle about the reference axis of the seat; and
a return swivel mode in which the seat is rotated back to the return position.

6. The apparatus of claim 5, wherein the switch is configured to be turned on by physical contact with the seat based on the seat being swiveled to the return position.

7. The apparatus of claim 5, further comprising:
a camera positioned to face the seat and configured to obtain a seat image by photographing at least a portion of the seat.

8. The apparatus of claim 7, wherein the controller circuit is configured to determine the swiveled position of the seat based on:
a rotation line of an upper plate of the seat rotating circuit and a fixing line of a lower plate of the seat rotating circuit being aligned in a straight vertical line in the seat image, and
a position of the seat corresponding to the return swivel mode.

9. The apparatus of claim 5, wherein the controller circuit is configured to determine whether to switch the swivel mode based on at least one of:
whether power of a vehicle provided with the seat is in a utility mode,
a stopped state of the vehicle,
a Park-stage state of a transmission provided in the vehicle,
a seat seating state of a passenger for the seat,
a fastening state of a safety buckle provided in the seat,
a manual operation state of the seat,
a state in which the return swivel mode of the seat is completed,
a swivel operation state of another seat positioned next to the seat, or
whether to inflate an airbag of the vehicle provided with the seat.

10. The apparatus of claim 9, wherein the controller circuit is configured to:
determine whether to inflate the airbag,
output, based on the determination of whether to inflate the airbag, information indicating whether inflation of the airbag is unavailable,
identify, based on the output information, whether a user agrees to proceed with seat swiveling, and
determine whether to swivel the seat based on:
the identification of whether the user agrees to proceed with seat swiveling, and
a swivel mode switching command received from the user.

11. A method performed by an apparatus, the method comprising:
driving a motor configured to swivel a seat;
detecting, via a sensor of the apparatus, a pulse generated based on the driving of the motor;
detecting a state of a switch switched based on a swiveled position of the seat;
determining the swiveled position of the seat based on a number of pulses detected via the sensor; and
determining whether to activate a vehicle function, based on at least one of:
the swiveled position of the seat,
the number of the detected pulses being within a preset effective range, or
the state of the switch.

12. The method of claim 11, wherein the determining of whether to activate the vehicle function comprises activating the vehicle function based on:
the swiveled position of the seat being an initial position,
the number of the detected pulses being within the preset effective range, or
the state of the switch being turned on, and wherein the vehicle function comprises a gear shifting and a driving.

13. The method of claim 11, further comprising:
receiving a swivel mode switching command from a command input interface;
determining, based on the swivel mode switching command, whether to switch a swivel mode; and
outputting, based on a determination to switch the swivel mode, a control signal for controlling the driving of the motor.

14. The method of claim 11, wherein the determining of the swiveled position of the seat comprises, based on a corresponding swivel mode selected from a plurality of swivel modes, determining the swiveled position of the seat,
wherein each of the plurality of swivel modes is associated with a respective range of a number of pulses detected via the sensor, and
wherein each range of a number of pulses detected via the sensor is preset from an operation start time point of the motor to an operation completion time point of the motor for swiveling of the seat.

15. The method of claim 14, wherein the plurality of swivel modes comprises:
a partial swivel mode in which the seat is rotated from a return position corresponding to 0° to a first angle about a reference axis of the seat;
a full swivel mode in which the seat is rotated from the return position to a second angle about the reference axis of the seat; and
a return swivel mode in which the seat is rotated back to the return position.

16. The method of claim 15, wherein a seat rotating circuit of the apparatus is configured to swivel the seat via the driving of the motor, and wherein the determining of the swiveled position of the seat is based on:
a rotation line of an upper plate of the seat rotating circuit and a fixing line of a lower plate of the seat rotating circuit being aligned in a straight vertical line in a seat image captured by a camera of the apparatus, and
a position of the seat corresponding to the return swivel mode.

17. The method of claim 15, further comprising:
determining whether to switch a swivel mode based on at least one of:
whether power of a vehicle provided with the seat is in a utility mode,
a stopped state of the vehicle,
a Park-stage state of a transmission provided in the vehicle,
a seat seating state of a passenger for the seat,
a fastening state of a safety buckle provided in the seat,
a manual operation state of the seat,
a state in which the return swivel mode of the seat is completed,
a swivel operation state of another seat positioned next to the seat, or
whether to inflate an airbag of the vehicle provided with the seat.

18. An apparatus of a vehicle, the apparatus comprising:
a seat;
a motor configured to rotate the seat; and
a controller circuit configured to:
cause the seat to move into a clearance position before rotating the seat,
rotate the seat based on a received mode command,
obtain data, via a sensor, indicative of a position of the seat,
verify, based on the data, the position of the seat after the rotation,
classify the verified position of the seat as one of a plurality of zones, and
control, based on the classified one of the plurality of zones, a function of the vehicle.

19. The apparatus of claim 18, wherein the function of the vehicle comprises at least one of:
enabling or disabling gear shifting,
allowing or preventing vehicle driving, or
transitioning a power condition of the vehicle between a utility mode and a driving mode.

20. The apparatus of claim 18, wherein the plurality of zones comprise:
a first zone corresponding to a partial swivel range from a return position to a first angle about a reference axis of the seat; and
a second zone corresponding to a full swivel range from the return position to a second angle greater than the first angle.
